(19) United States
(12) Patent Application Publication
(10) Pub. No.: US 2012/0173735 A1
(43) Pub. Date: Jul. 5, 2012

(54) Radio Tool and Method for the Operation Thereof

(75) Inventor: Martin Eckert, Neuenstein (DE)

(73) Assignee: Robert Bosch GmbH, Stuttgart (DE)

(21) Appl. No.: 13/337,223

(22) Filed: Dec. 26, 2011

(30) Foreign Application Priority Data
Dec. 30, 2010 (DE) 10 2010 056 497.4

(51) Int. Cl. G06F 15/16; H04W 84/02

(52) U.S. Cl. 709/227

(57) ABSTRACT

A method for wireless communication between at least two portable tools is disclosed. The tools each comprise a mechanism for wireless communication and also a data memory and a tool controller. The first tool is configured as a server and the second tool is configured as a client, wherein the second tool sets up a communication link to the first tool.

This application claims priority under 35 U.S.C. §119 to patent application no. DE 10 2010 056 497.4, filed on Dec. 30, 2010 in Germany, the disclosure of which is incorporated herein by reference in its entirety.

### BACKGROUND

The disclosure relates to a radio tool and a method for the operation thereof.

Handheld tools, particularly storage-battery-operated screwing tools, are known. Such tools are used on production lines in the automotive industry, for example.

Such tools are suitable for communication using a PC base station and usually comprise a data memory and a tool controller, which uses the data held in the data memory to control the screwing operation.

When new tools are started up on existing production lines, identical parameters (e.g. screwing programs) are often required for a plurality of tools.

Each tool needs to be manually coupled to the PC base station and configured as appropriate. If the intention is for a plurality of tools to operate with identical data records, all of these tools need to be configured by an operator as appropriate prior to being started up.

This configuration is firstly very complex and secondly also error prone, since human error could mean that the tool is also configured with incorrect parameters.

Features of the disclosure eliminate these drawbacks by allowing simple and effective configuration of the data records on the tools. Features of the disclosure can be transferred to any type of tools.

Features of the disclosure achieve the aforementioned advantages by implementing a method for wireless communication between at least two portable tools.

### SUMMARY

A tool according to the disclosure is suitable for wireless communication with a tool of the same kind and comprises at least one radio module for setting up the wireless communication with a tool of the same kind or of a different kind, a data memory and a tool controller which can be parameterized by means of the radio module.

A tool configured as a client can make contact with a tool configured as a server, which then provides it with the service. The client is able to use this service. By way of example, the service may define data interchange between the two tools, so that the client can receive data from the server and can use and/or present said data. At least one client program and a server program are comprised by each tool according to the disclosure.

Tools according to the disclosure comprise a display means which can be used to present tools of the same kind which are in range of the radio module, as a result of which the operator can easily select one of these tools. The operator therefore actively determines those tools with which he wishes to interchange data.

For the method according to the disclosure, the first tool is configured as a server and the second tool is configured as a client. The second tool sets up a communication link to the first tool and retrieves data from the data memory which the first tool comprises. It stores these data on the data memory which the second tool comprises, so that both tools have at least partially identical data records on them.

The tool can be configured either as a server or as a client in the framework. The server is implemented as a program which can be executed on a microprocessor which the tool comprises, and provides a service. Within the framework of the client/server model which the features of the disclosure use, it is possible for a different program which can be executed on a microprocessor which the tool likewise comprises, the client, to use the service provided by the server. The server is always on standby so as to be able to react to a client making contact at any time. The rules of the communication (format, call to the server, and the significance of the data interchanged between server and client) are stipulated by means of a protocol for the service provided. The client is likewise a program which can be executed on a microprocessor which the tool comprises.

Both tools therefore have synchronous data records and can execute tasks of the same kind. Manual configuration or safeguarding of the synchronicity is always ensured because it is readily possible for alignment algorithms also to be implemented which check the identity of the transmitted data once again before the tools are started up. This can be done automatically and without any complexity for the operator and/or maintenance personnel.

In order to avoid unauthorized access, preferably, before retrieving the data, the second tool transmits a user name and/or a password to the first tool and the first tool verifies these prior to the data transmission. If the security check is unsuccessful, the first tool denies the second tool data access.

After retrieving the data, the second tool initiates the connection setup. Both tools can then be operated independently of one another with identical data, and tasks to be executed in sync can be accomplished in parallel.

Ideally, the second tool transmits a file list to the first tool, wherein the first tool locates the files which the file list contains in its data memory and keeps them for the subsequent retrieval by the second tool. The first tool transmits an identifier specific to the data intended to be retrieved to the second tool. The second tool then uses the identifier to retrieve the data from a first tool and stores said data in its data memory. These method steps allow not only individual files but also whole data records, comprising a plurality of files, to be retrieved as part of a single operation. Preferably, the file list and the identifier are effected using the TCP/IP protocol and the file transmission is effected using the FTP protocol. These protocols can easily be incorporated into existing communication infrastructures. Appropriate software stacks are present for the most common microprocessors.

In order to speed up the data transmission, the first tool compresses the data intended to be retrieved by the second tool in an archive file prior to the retrieval and preferably provides this file with a checksum, wherein the file name for the archive file corresponds to the identifier. The size of the archive file is usually smaller than the size of the individual files in the data record. It is therefore necessary to transmit fewer bytes, which increases the speed of data transmission. The second tool reverses the compression of the data again when they have been received and checks the data preferably using the checksum. The data are then available again for use on the second tool.

For the method according to the disclosure, the tools which are in range for communication with one another are listed on a display apparatus which the tool comprises. However, the communication link between two tools is preferably not set up until the operator has selected one or more of the tools displayed on the display apparatus.

The method is preferably used to transmit data which are used as an operating program for the tool controller and are loaded into the tool controller, as a result of which it is a simple matter to implement the synchronous operation between the tools.

Preferably, the tools are storage-battery-operated screwing tools. These may be used as handheld tools on production lines in the automotive industry. The workers on the same production line frequently need to carry out similar or identical screwing tasks in parallel. Features of the disclosure facilitate the data synchronization of the screwing tools with one another.

### BRIEF DESCRIPTION OF THE DRAWINGS

FIG. 1 shows the design of the protocols which can be executed by means of the firmware in a screwing tool.

FIG. 2 shows the sequence of the synchronization using a file list.

FIG. 3 shows a perspective view of a screwdriver with the data display for presenting all the screwdrivers which are present in the radio range of the WLAN module which the screwdriver comprises.

### DETAILED DESCRIPTION

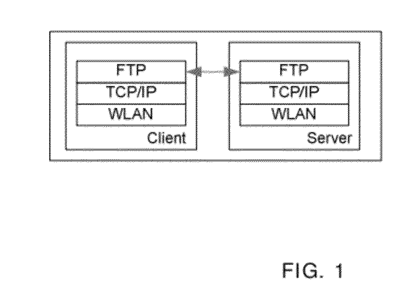

FIG. 1 shows the design of the protocols which can be executed by means of the firmware in a screwing tool. The data synchronization can be started by means of the screwdriver controller. A data display on the screwdriver is used to display all screwdrivers which are in the radio network. The selection of the displayed screwdriver starts the synchronization phase between the two screwdrivers. Since the data intended to be synchronized are remote as files on the screwdrivers, it is possible to use the FTP protocol.

The first screwdriver, which prompts the synchronization, behaves as an FTP client and the second screwdriver, with which synchronization is intended to take place, behaves as an FTP server. The synchronization is broken down into the following steps:
connection setup from the client to the server
transmission of user and password from client to server
requesting and receiving of the files intended to be synchronized
connection cleardown
read-in of the received files.

The list of files intended to be requested is stored in the firmware of the first screwdriver. The second screwdriver selected by the user automatically acts as a server as soon as it has been selected.

In theory, it would also be possible to set up a communication ring, so that the screwdrivers synchronize themselves according to a prescribable order. It would also be conceivable for automatic synchronization to take place, i.e. for each screwdriver on a production line to contact the respective other screwdrivers and to compare the currentness of the data records. The screwdriver used in this case comprises a WLAN module which is used to implement the physical connection layer shown in FIG. 1 (WLAN).

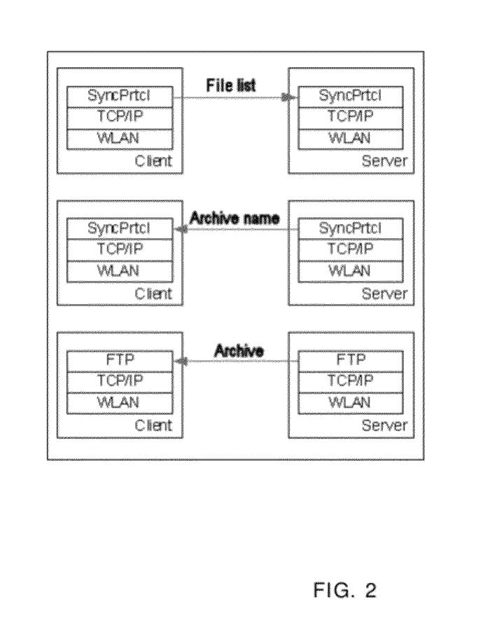

FIG. 2 shows the sequence of the synchronization using a file list.

The files required by the client for the synchronization are preferably not requested individually but rather are transmitted to the server as a file list using a proprietary protocol “SyncPrtcl”.

In this regard, the client uses the TCP/IP protocol to connect to the server using a WLAN module which the screwdriver comprises. The server packs the files required into an archive and notifies the client of the file name of the archive “archive name” in the response and likewise using the same proprietary protocol “SyncPrtcl”. The client then breaks the connection and retrieves the archive file, as already described for FIG. 1, from the server using the FTP protocol. The archive is then unpacked by the client and the files are read in by the screwdriver controller.

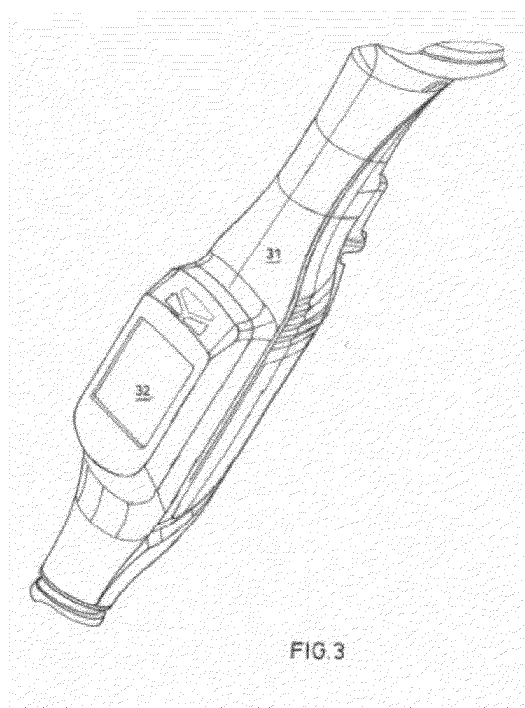

FIG. 3 shows a screwdriver 31 with the data display 32 for presenting all the screwdrivers which are present in the radio range of the WLAN module which the screwdriver comprises.

What is claimed is:

1. A method for wireless communication between at least two portable tools that include a first tool and a second tool, which tools each comprise a mechanism for wireless communication and also a data memory and a tool controller, wherein the first tool is configured as a server and the second tool is configured as a client, wherein the second tool sets up a communication link to the first tool.

2. The method according to claim 1, wherein the second tool retrieves data from the data memory which the first tool comprises and stores said data on the data memory which the second tool comprises, as a result of which both tools have at least partially identical data records on them.

3. The method according to claim 1, wherein, before retrieving the data, the second tool transmits a user name and/or a password to the first tool and the first tool verifies these in order to clear the data transmission.

4. The method according to claim 1, wherein, after retrieving the data, the second tool initiates the connection setup and wherein both tools operate independently of one another with identical data.

5. The method according to claim 1, wherein both tools comprise a WLAN module and wherein the WLAN module is used to provide a communication link between the two tools, wherein the second tool transmits a file list to the first tool and wherein the first tool at least to some extent locates the files which the file list contains in its data memory and keeps them for retrieval by the second tool, wherein the first tool transmits an identifier specific to the data to the second tool, wherein the second tool then uses the identifier to retrieve the data from a first tool and stores said data in its data memory.

6. The method according to claim 5, wherein the file list and the identifier are effected using the TCP/IP protocol and the file transmission is effected using the FTP protocol.

7. The method according to claim 5, wherein the first tool compresses the data intended to be retrieved by the second tool in an archive file prior to the retrieval and provides this file with a checksum, wherein the file name for the archive file corresponds to the identifier.

8. The method according to claim 7, wherein the second tool reverses the compression of the data and checks the data using the checksum after it has received the data.

9. The method according to claim 1, wherein tools which are in range for communication are listed on a display apparatus which the tool comprises, wherein the communication link between two tools is not set up until the operator has selected one of the tools displayed on the display apparatus.

10. The method according to claim 1, wherein the method is used to transmit data which are used as an operating program for the tool controller and are loaded into the tool controller, as a result of which it is possible to implement synchronous operation between the tools.

11. The method according to claim 1, wherein the tools are storage-battery-operated screwing tools.

12. A tool for wireless communication with another tool of the same kind, comprising:
a radio module configured to set up the wireless communication to the other tool of the same kind,
a data memory,
a tool controller, wherein the tool is configured either as a server or as a client for the communication, and
a display mechanism configured to present tools of the same kind which are in range of the radio module, as a result of which the operator is able to select one of these tools.
